(19) United States
(12) Patent Application Publication
(10) Pub. No.: US 2022/0390886 A1
(43) Pub. Date: Dec. 8, 2022

(54) IMAGE FORMING APPARATUS

(71) Applicant: CANON KABUSHIKI KAISHA, Tokyo (JP)

(72) Inventor: Kazunori Matsubayashi, Saitama (JP)

(21) Appl. No.: 17/831,742

(22) Filed: Jun. 3, 2022

(30) Foreign Application Priority Data
Jun. 4, 2021 (JP) 2021-094281

(51) Int. Cl. G03G 15/00; G03G 15/20

(52) U.S. Cl. CPC G03G 15/5008; G03G 15/2064

(57) ABSTRACT

An image forming apparatus includes: a fixing roller configured to fix an image on a sheet with heat, a rotary member configured to form a nip portion with the fixing roller and driven by the fixing roller, a motor configured to drive the fixing roller, a motor control unit configured to control the motor, a current detection unit configured to detect a current value of a current flowing through the motor, a controller configured to: determine whether or not a stick-slip phenomenon has occurred based on the current value; increase a rotation speed of the motor in a case where the stick-slip phenomenon has occurred, decrease the rotation speed of the motor in a case where the stick-slip phenomenon has not occurred.

### BACKGROUND OF THE INVENTION

### Field of the Invention

The present disclosure relates to an image forming apparatus, such as a printer, a multifunction apparatus, and a copier which control a drive source such as a motor to drive load.

### Description of the Related Art

In the office, some people find a noise generated by motors of office equipment such as an image forming apparatus placed near people unpleasant. Therefore, in recent years, there has been an increasing demand for reducing the noise of devices having motors. Therefore, the office equipment is often equipped with a motor which employs noise reduction technology.

To reduce the noise, it is desired to avoid a stick-slip phenomenon, which is one of the noise factors. The stick-slip phenomenon is a phenomenon in which when a surface of a friction portion on a load side is rubbed, an object in contact with the load at the friction portion repeats, between the object and the load, a state of sliding and a state of stopping. The stick-slip phenomenon causes an abnormal noise from the friction portion. U.S. patent Ser. No. 10/836,594 B2 discloses a technique for suppressing the generation of the stick-slip phenomenon of the image forming apparatus to reduce a noise. This image forming apparatus suppresses, in a case where a load change of a feeding motor is detected, an occurrence of the stick-slip phenomenon by increasing a rotation speed of the feeding motor to a predetermined speed to drive the load.

In order to suppress the occurrence of the stick-slip phenomenon, firstly, it is necessary to detect the occurrence of the stick-slip phenomenon. To detect the stick-slip phenomenon by a mechanical detection device, for example, a sensor for vibration detection is required, which increases the cost. In this case, it is necessary to additionally provide the detection device in a main body of an apparatus such as an image forming apparatus, the size of the entire apparatus tends to be large.

Further, by increasing the rotation speed of the motor to suppress the stick-slip phenomenon, the driving sound of the motor itself becomes loud even if the stick-slip phenomenon is suppressed.

In view of the above problems, it is an object of the present disclosure to provide a drive source control device which suppresses noise in both cases when the stick-slip phenomenon occurs and when it does not occur.

### SUMMARY OF THE INVENTION

An image forming apparatus according to the present disclosure includes: a fixing roller configured to fix an image on a sheet with heat, a rotary member configured to form a nip portion with the fixing roller and driven by the fixing roller, a motor configured to drive the fixing roller, a motor control unit configured to control the motor, a current detection unit configured to detect a current value of a current flowing through the motor, a controller configured to: determine whether or not a stick-slip phenomenon has occurred based on the current value; increase a rotation speed of the motor in a case where the stick-slip phenomenon has occurred, decrease the rotation speed of the motor in a case where the stick-slip phenomenon has not occurred.

Further features of the present invention will become apparent from the following description of exemplary embodiments (with reference to the attached drawings).

### BRIEF DESCRIPTION OF THE DRAWINGS

FIG. 1 is a configuration diagram of an image forming apparatus.

FIG. 2 is an exemplary diagram representing current values when a stick-slip phenomenon occurs.

FIG. 3 is an exemplary diagram representing the current values when the stick-slip phenomenon occurs.

FIG. 4 is an exemplary diagram representing the current values when the stick-slip phenomenon is suppressed.

FIG. 5 is an exemplary diagram representing the current values when the stick-slip phenomenon is suppressed.

FIG. 6 is a flow chart representing a control process of the fixing heater.

### DESCRIPTION OF THE EMBODIMENTS

Hereinafter, an embodiment of the present disclosure will be described with reference to the drawings.

### <Configuration of Image Forming Apparatus>

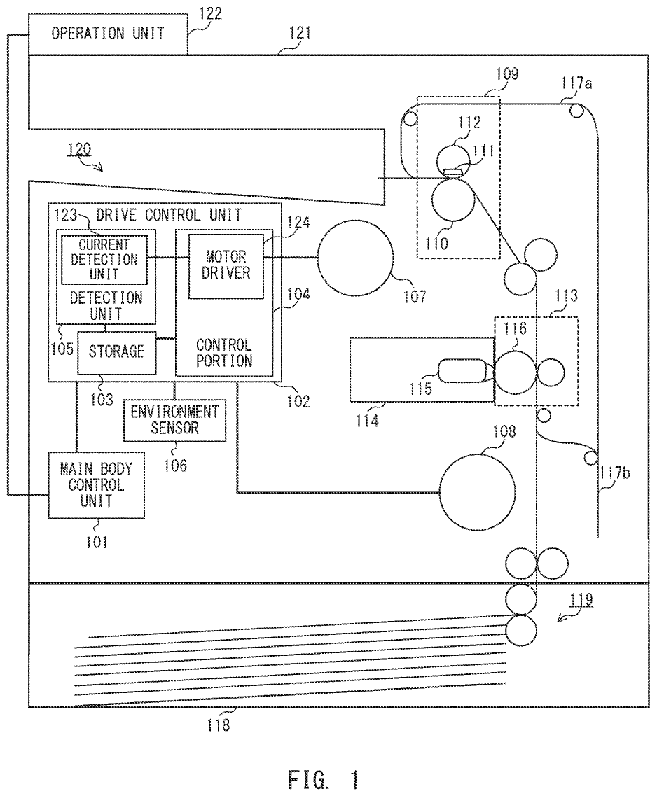

FIG. 1 is a configuration diagram of an image forming apparatus having a drive source control device of the present embodiment. A drive control unit 102 as the drive source control device is installed in the image forming apparatus 121. The image forming apparatus 121 has a sheet container 118, a feeding unit 119, a transfer unit 113, and a fixing device 109. An operation unit 122 is arranged at an upper part of the image forming apparatus 121. The drive control unit 102 has a control portion 104, a detection unit 105, and a storage 103. The control portion 104 includes a motor driver 124. The detection unit 105 includes a current detection unit 123. A fixing motor 107, a drive motor 108, an environment sensor 106, and a main body control unit 101 are connected to the drive controller.

The operation unit 122 is a user interface having an input interface and an output interface. The input interface is a key button, a touch panel, or the like. The output interface is a display, a speaker, or the like. The image forming apparatus 121 operates according to instructions input from the operation unit 122. The operation unit 122 displays various setting screens and a notification of a status of the image forming apparatus 121.

The sheet container 118 stores a sheet on which an image is to be printed. The feeding unit 119 feeds sheets in sheet container 118 one by one. The feeding unit 119 conveys the sheet from the sheet container 118 to the transfer unit 113. The transfer unit 113 includes a drum 116 on which a toner image is to be formed. The transfer unit 113 transfers the toner image supported by the drum 116 to the sheet conveyed by the feeding unit 119. The drum 116 is rotationally driven around the drum shaft by the drive motor 108.

In the vicinity of the drum 116, a cartridge 114 having a cleaning blade 115 is provided to contact with a surface of the drum 116. The cleaning blade 115 removes the toner remaining on the surface of the drum 116 after transferring the toner image.

The sheet on which the toner image has been transferred is conveyed from the transfer unit 113 to the fixing device 109. The fixing device 109 has a fixing film 112, in which a fixing heater 111 is installed, and a pressing roller 110. The fixing motor 107 is a drive source for rotating the pressing roller 110. The fixing device 109 sandwiches and conveys the sheet by the fixing film 112 and the pressing roller 110. At that time, the toner image supported by the sheet is heated and melted by the fixing heater 111, pressed by the pressing roller 110, and fixed on the sheet. The sheet on which the image is formed in this way is discharged to the discharge unit 120.

In the case of double-sided printing, the sheet on which an image is formed on one side is conveyed from the fixing device 10) to a double-sided path 117a. The sheet conveyed to the double-sided path 117a is conveyed to an inversion path 117b. The sheet is conveyed to the transfer unit 113 again after a conveyance direction is inverted in the inversion path 117b. By inverting the conveyance direction in the inversion path 117b, the surface on which the image is to be formed is inverted. Thus, the sheet is conveyed to the transfer unit 113 via the double-sided path 117a and the inversion path 117b, so that the image is formed on the other side on which the image has not been formed.

The environment sensor 106 detects an environmental condition such as an ambient temperature and humidity around the image forming apparatus 121. The detected environmental condition is notified to the drive control unit 102. The main body control unit 101 controls the operation of each part in the image forming apparatus 121 to perform the image forming process on the sheet as described above. The main body control unit 101 is connected to the operation unit 122 to receive instructions or the like input from the operation unit 122. Further, the main body control unit 101 displays the status of the image forming apparatus 121 and the like on the operation unit 122.

The drive motor 108 and the fixing motor 107 are driven and controlled by the drive control unit 102. A motor driver 124 drives the fixing motor 107. The current detection unit 123 detects a current value of the current flowing through the fixing motor 107 and the drive motor 108. For example, a power supply voltage is applied to the fixing motor 107 from the motor driver 124. The current detection unit 123 detects the energizing current of the power supply voltage line which applies the power supply voltage from the motor driver 124 to the fixing motor 107. The storage 103 stores setting speeds of the fixing motor 107 and the drive motor 108, and the setting speeds are read when performing the drive control of the fixing motor 107 and the drive motor 108. The motor driver 124 rotates and drives the fixing motor 107 at a speed corresponding to the setting speed.

The drive control of the fixing motor 107 will be described. The fixing motor 107 is a drive source for the fixing device 109, and the fixing device 109 serves as a load. The fixing film 112 is rotationally driven by the pressing roller 110 which is rotationally driven by the fixing motor 107. At this time, both the fixing heater 111 installed in the fixing film 112 and the support member of the fixing heater 111 are in contact with the fixing film 112 to slide. The stick-slip phenomenon may occur between the fixing film 112 and the fixing heater 111 due to the frictional force during sliding. The occurrence of the stick-slip phenomenon causes an abnormal noise and causes discomfort to the user. The stick-slip phenomenon occurs in a case where a sliding portion vibrates when a dynamic friction force and a static friction force are switched.

The drive control unit 102 controls the rotation speed of the fixing motor 107 in order to suppress the occurrence of the stick-slip phenomenon. In a case where the fixing motor 107 is operated at a low speed, the static friction force of the sliding portion on the load side (the contact portion between the fixing film 112 and the fixing heater 111) increases to thereby change the sliding portion elastically in a fixed state. After that, when a predetermined force is applied to the sliding portion, the sliding portion slides to operate. During a low speed operation, at the contact area between the film 112 and the fixing heater 111, the above sticking state and a sliding state are repeated. Therefore, the stick-slip phenomenon occurs and causes vibrations in the fixing device 109 to generate the abnormal noise.

When the rotational speed of the fixing motor 107 increases, after becoming the sliding state, the sliding portion continues to slide without becoming sticking state. Therefore, the stick-slip phenomenon is eliminated and the abnormal noise dos not occur. Thus, by increasing the rotation speed of the fixing motor 107 when the stick-slip phenomenon occurs, the stick-slip phenomenon is suppressed. By suppressing the stick-slip phenomenon, it becomes possible to avoid the vibration of the fixing device 109 (load), which is a source of the abnormal noise.

### <Determination of Occurrence of Stick-Slip Phenomenon>

In the present embodiment, the occurrence of the stick-slip phenomenon is detected based on the current of the fixing motor 107 detected by the current detection unit 123. The current detection unit 123 detects the energizing current of the power supply voltage line of the fixing motor 107. The drive control unit 102 detects the occurrence of the stick-slip phenomenon when the current value of the energizing current detected by the current detection unit 123 is equal to or less than a predetermined value.

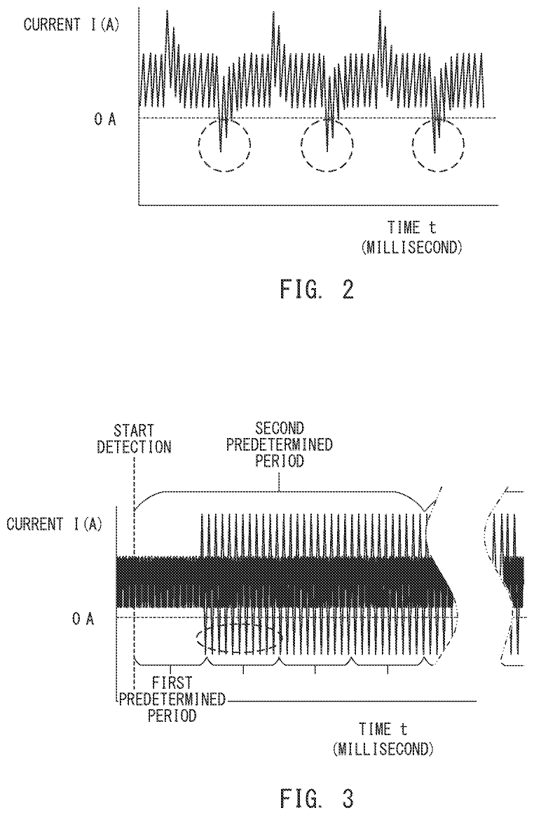

FIG. 2 and FIG. 3 are exemplary diagrams representing the current values when the stick-slip phenomenon occurs. The occurrence of the stick-slip phenomenon is detected when the current value of the fixing motor 107 becomes equal to or less than a predetermined current value. In FIG. 2, a current value which is equal to or less than a predetermined current value is detected in each portion circled by a broken line. In the present embodiment, the predetermined current value is set to 0 A (ampere), and it is determined that the stick-slip phenomenon has occurred in a case where the detected current value has a negative current value (negative value). The negative current value is generated by a counter electromotive force generated by breaking the fixing motor 107.

As shown in FIG. 3, when the generation of the negative current value is detected more than a first predetermined number of times within a first predetermined period, it is determined that the stick-slip phenomenon is generated and a load torque of the fixing motor 107 is changed. For example, the drive control unit 102 determines that the stick-slip phenomenon has occurred by detecting the negative current value 10 times or more in 50 milliseconds. After determining that the stick-slip phenomenon has occurred, the drive control unit 102 increases the rotation speed of the fixing motor 107 by the motor driver 124. As a result, the stick-slip phenomenon is suppressed. The first predetermined period is longer than, for example, one cycle (cycle between the fixed state and the slipped state) of the stick-slip phenomenon and is a period during which the change of the current value due to the change of torque of the fixing motor 107 can be detected two or more times.

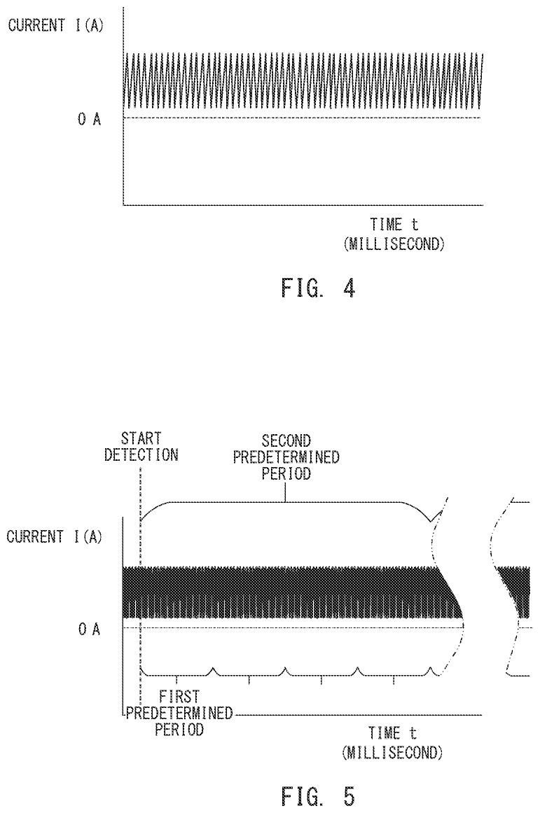

FIG. 4 and FIG. 5 are exemplary diagrams of the current values in a case where the stick-slip phenomenon is suppressed after the occurrence of the stick-slip phenomenon. Since the negative current (current having a value less than or equal to the predetermined current value) is not generated, the drive control unit 102 determines that the stick-slip phenomenon is suppressed. The rotation speed of the fixing motor 107 remains higher than usual because the stick-slip phenomenon is suppressed. Therefore, the rotation speed of the fixing motor 107 is faster than necessary, and the stick-slip phenomenon may not occur even if the rotation speed is slowed down. In this regard, to reduce a driving noise of the fixing motor 107, it is preferable to slow down the rotation speed of the fixing motor 107 as much as possible.

Therefore, after determining that the stick-slip phenomenon has not occurred, the drive control unit 102 reduces the rotation speed of the fixing motor 107 by the motor driver 124. As a result, the driving noise of the fixing motor 107 is reduced. For example, if the current value does not become less than the predetermined current value (for example, 0 A) within the second predetermined period shown in FIG. 5, the drive control unit 102 reduces the rotation speed of the fixing motor 107. The second predetermined period is longer than the first predetermined period and is a predetermined integer multiple of the first predetermined period. In FIG. 5, the second predetermined period is four times the first predetermined period. The condition for reducing the rotation speed of the fixing motor 107 may be a condition where the number of times the current value becomes equal to or less than the predetermined current value within the second predetermined period is less than or equal to the predetermined number of times. In this case, the predetermined number of times is determined according to the number of times that the drive torque change of the fixing motor 107 suddenly changes within the second predetermined period for some reason.

As described with reference to FIG. 2 to FIG. 5, the drive control unit 102 of the present embodiment determines, based on the detection result of the current value of the current flowing through the fixing motor 107, whether or not the stick-slip phenomenon has occurred and controls the rotation speed of the fixing motor 107. In a case where the stick-slip phenomenon has occurred, the drive control unit 102 changes the rotation speed of the fixing motor 107 to a high speed to suppress the stick-slip phenomenon. In a case where the stick-slip phenomenon has not occurred, the drive control unit 102 reduces the driving sound by reducing the rotation speed of the fixing motor 107 as much as possible. As a result, the fixing motor 107 can operate such that the stick-slip phenomenon does not occur in a state where the driving noise is reduced as much as possible. In this way, the drive control unit 102 realizes a motor control that reduces the noise that makes the user uncomfortable.

### <Drive Control Process of Fixing Motor 107>

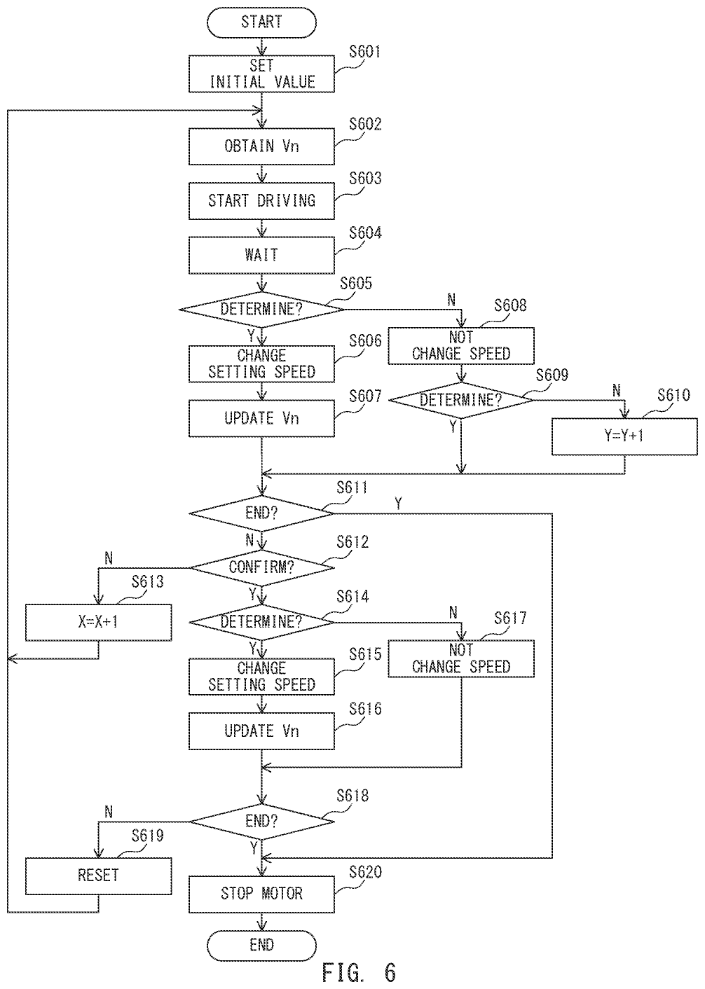

FIG. 6 is a flowchart representing a drive control process of the fixing motor 107 by the drive control unit 102. This process is executed when the image forming apparatus 121 performs an image forming process on the sheet.

Firstly, as to the number of loops of a current detection X and the number of times for which the negative current does not flow Y, the drive control unit 102 sets these numbers to the initial value “0” (Step S601). The number of loops X represents the number of repetitions in the first predetermined period. Next, the drive control unit 102 obtains the setting speed Vn of the fixing motor 107 from the storage 103 (Step S602). The setting speed Vn is set according to a type of the sheet and a content of the fixing process, and corresponds to the rotation speed of the pressing roller 110. The drive control unit 102 starts driving the fixing motor 107 at the setting speed Vn (Step S603). The drive control unit 102 waits until the fixing motor 107 rotates stably at a speed corresponding to the setting speed Vn (Step S604).

In a state where the fixing motor 107 is stably rotationally driven at a speed corresponding to the setting speed Vn, the drive control unit 102 detects the current of the fixing motor 107 by the current detection unit 123. As to the number of times the detected current value becomes negative, the drive control unit 102 determines whether or not the number of times is equal to or more than the first predetermined number of times in the first predetermined period (Step S605). In the present embodiment, the drive control unit 102 determines whether or not the number of detections of the current value becomes negative is 10 times or more in 50 milliseconds.

In a case where the number of times the negative current value is detected is 10 times or more in 50 milliseconds (Step S605: Y), the drive control unit 102 determines that the change of torque has occurred in the fixing motor 107. As a result, the drive control unit 102 determines that the stick-slip phenomenon has occurred in the fixing device 109. In this case, the drive control unit 102 changes the setting speed Vn to a speed V(n+1) which is faster than the setting speed Vn by a speed P (Step S606). That is, the velocity V(n+1)=Vn+P. The speed P is a value preset in order to increase the rotation speed of the fixing motor 107 stepwise at each first predetermined period. The speed P is a value set according to a type of the image forming apparatus 121. The drive control unit 102 updates the setting speed Vn in the storage 103 by overwriting it by the setting speed V(n+1) of the fixing motor 107 (Step S607). As a result, in the next process, the fixing motor 107 is rotationally driven at the updated setting speed V (n+1).

When the number of times the negative current value is detected is less than 10 times in 50 milliseconds (Step S605: N), the drive control unit 102 determines that the stick-slip phenomenon has not occurred in the fixing device 109. In this case, the drive control unit 102 does not change the rotation speed of the fixing motor 107 (Step S608). The current value of the fixing motor 107 may become a negative value under the control of the fixing motor 107. In a case where the stick-slip phenomenon occurs, the negative current values constantly occur. In a case where the negative current values do not constantly occur, it is not necessary to change the rotation speed of the fixing motor 107. The drive control unit 102 determines whether or not the change of torque of the fixing motor 107 has occurred depending on whether or not the number of detections of the negative current value in the processing of Step S605 is 1 or more (Step S609). In a case where the number of detections of the negative current value in the process is less than one (Step S609: N), the drive control unit 102 determines that the torque of the fixing motor 107 has not changed, and increases the number of times Y that the negative current does not flow is by 1 (Step S610). In a case where the number of detections of the negative current value in the process is one or more (Step S609: Y), the drive control unit 102 skips the process of Step S610.

After the process of Step S607, the process of Step S609, or the process of Step S610, the drive control unit 102 determines whether or not to end the image forming process (Step S611). When it is determined to end the process (Step S611: Y), the drive control unit 102 stops the operation of the fixing motor 107 to end the process (Step S620).

When it is determined not to end the process (Step S611: N), the drive control unit 102 confirms the number of loops X in order to repeat the detection of the current value in the first predetermined period a predetermined number of times (Step S612). In the present embodiment, the number of times the current value detection is repeated (the number of times of repetition of the first predetermined period) is set to 40 times. Therefore, the drive control unit 102 confirms whether or not the number of loops X is “40”. In a case where the loop count X is not “40” (Step S612: N), the drive control unit 102 adds 1 to the loop count X and performs the processing after Step S602 again (Step S613). Here, since the first predetermined period of the processing of Step S605 is 50 milliseconds and the number of times the current value detection is repeated is set to 40 times, the second predetermined period is the product of 50 milliseconds and 40 times, i.e., 2 seconds.

In a case where the number of loops X is “40” (Step S612: Y), the drive control unit 102 determines whether or not the number of times that the negative current does not flow is equal to 40 times, which is the number of times the current value detection is to be repeated (Step S614). In a case where the number of times Y is not equal to 40 times (Step S614: N), the drive control unit 102 determines that the change of torque of the fixing motor 107 has occurred and does not change the rotation speed of the fixing motor 107 (Step S617). That is, the drive control unit 102 does not change the rotation speed of the fixing motor 107 when the negative current flows even once within the second predetermined period.

In a case where the number of times Y is equal to 40 times (Step S614: Y), it means that the negative current has not occurred within the second predetermined period, therefore, the drive control unit 102 determines that the change of torque of the fixing motor 107 has not occurred and determines that the rotation speed of the fixing motor 107 may be reduced. Therefore, the drive control unit 102 changes the setting speed Vn of the fixing motor 107 to a speed V (n−1) slower than the setting speed Vn by a speed Q (Step S615).

That is, the velocity V(n−1)=Vn-Q.

The speed Q is a value preset in order to decrease the rotation speed of the fixing motor 107 stepwise at each second predetermined period. The speed Q is a value set according to the type of the image forming apparatus 121. The drive control unit 102 updates the setting speed V(n) in the storage 103 by overwriting it by the setting speed V(n−1) of the fixing motor 107 (Step S616). As a result, in the next process, the fixing motor 107 is rotationally driven at the updated setting speed V (n−1).

After the process of Step S616 or the process of Step S617, the drive control unit 102 determines whether or not to end the image forming process (Step S618). When it is determined to end the process (Step S618: Y), the drive control unit 102 stops the operation of the fixing motor 107 to end the process (Step S620). When it is determined not to end the process (Step S618: N), as to the number of loops of a current detection X and the number of times for which the negative current does not flow Y, the drive control unit 102 resets these numbers to the initial value “0” (Step S619). After resetting, the drive control unit 102 repeats the processes after Step S602 until the image forming process is completed.

### <Drive Control of Drive Motor 108>

The drive motor 108, which is the drive source of the drum 116, is also controlled in the same manner as the fixing motor 107, so that the driving noise can be reduced while suppressing the occurrence of the stick-slip phenomenon. At the drum 116, the stick-slip phenomenon occurs at a position where the cleaning blade 115 slides. The load torque of the drive motor 108 changes due to the frictional force between the drum 116 and the cleaning blade 115. The drive motor 108 rotates and drives the drum 116, which is a load as a drive source.

The drive control unit 102 detects the change of the load torque of the drive motor 108 by measuring the current value of the drive motor 108. The drive control unit 102 determines that the stick-slip phenomenon has occurred when the current value of the drive motor 108 is detected more than the first predetermined number of times within the first predetermined period and determines to increase the rotation speed of the drive motor 108. The drive control unit 102 repeats the current detection of the drive motor 108 a predetermined number of times until the second predetermined period is reached, and decreases the rotation speed of the drive motor 108 to reduce the driving noise of the drive motor 108 when the negative current value is not detected during that period.

As described above, also in the drive motor 108 that rotationally drives the drum 116, in a case where the stick-slip phenomenon occurs, the rotational speed of the drive motor 108 is increased to eliminate the stick-slip phenomenon to reduce the noise. In a case where the stick-slip phenomenon does not occur, the rotation speed of the drive motor 108 is slowed down to reduce the driving noise. Due to the above control, the driving noise generated by the drive motor 108 can be reduced as much as possible regardless of presence or absence of the stick-slip phenomenon.

As described above, the image forming apparatus 121, having the drive source control, of the present embodiment detects the occurrence of the stick-slip phenomenon by the current value of the current flowing through the drive source such as the fixing motor 107 and the drive motor 108. In a case where the stick-slip phenomenon has occurred, the image forming apparatus 121 suppresses the noise generated by the stick-slip phenomenon by increasing the rotation speed of the drive source. In a case where the stick-slip phenomenon has not occurred, the image forming apparatus 121 suppresses the driving noise of the drive source by slowing down the rotation speed of the drive source. By controlling the drive source in this way, it is possible to suppress the noise generated from office equipment such as the image forming apparatus 121. As described above, according to the present disclosure, the noise can be suppressed both when the stick-slip phenomenon has occurred and when it has not occurred.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2021-094281, filed Jun. 4, 2021, which is hereby incorporated by reference herein in its entirety.

What is claimed is:

1. An image forming apparatus comprising:
a fixing roller configured to fix an image on a sheet with heat,
a rotary member configured to form a nip portion with the fixing roller and driven by the fixing roller,
a motor configured to drive the fixing roller,
a motor control unit configured to control the motor,
a current detection unit configured to detect a current value of a current flowing through the motor, and
a controller configured to:
determine whether or not a stick-slip phenomenon has occurred based on the current value;
increase a rotation speed of the motor in a case where the stick-slip phenomenon has occurred; and
decrease the rotation speed of the motor in a case where the stick-slip phenomenon has not occurred.

2. The image forming apparatus according to claim 1,
wherein the rotary member is a film which is driven by the fixing roller.

3. The image forming apparatus according to claim 1,
wherein the controller is configured to:
determine whether or not the stick-slip phenomenon has occurred based on a current value detected in a first predetermined period:
determine whether or not to decrease the rotation speed of the motor based on a current value detected in the second predetermined period longer than the first predetermined period.

4. The image forming apparatus according to claim 3, wherein the controller is configured to determine that the stick-slip phenomenon has occurred in a case where a current having a current value less than or equal to a predetermined current value is detected more than or equal to a predetermined number of times in the first predetermined period.

5. The image forming apparatus according to claim 3,
wherein the controller determines that the stick-slip phenomenon has occurred when a negative current value is detected a predetermined number of times or more in the first predetermined period.

6. The image reading apparatus according to claim 3, wherein the first predetermined period is longer than one cycle of the stick-slip phenomenon and is a period in which a change in the current value due to a change of a torque of the motor can be detected a plurality of times.

7. The image forming apparatus according to claim 3, wherein the controller is configured to decrease the rotation speed of the motor in a case where a current having a current value less than or equal to the predetermined current value is not detected in the second predetermined period, the second predetermined period being a period which is an integer multiple of the first predetermined period.

8. The image forming apparatus according to claim 3,
wherein the controller is configured to decrease the rotation speed of the motor in a case where a current having a current value less than or equal to the predetermined current value is not detected in the second predetermined period.

9. The image forming apparatus according to claim 3,
wherein the controller is configured to decrease the rotation speed of the motor in a case where a current having a negative current value is not detected in the second predetermined period.

10. The image forming apparatus according to claim 3,
wherein the controller is configured to:
increase the rotation speed of the motor stepwise at each first predetermined period in a case where the stick-slip phenomenon has occurred.

11. The image forming apparatus according to claim 3,
wherein the controller is configured to:
decrease the rotation speed of the motor stepwise at each second predetermined period in a case where the stick-slip phenomenon has not occurred.

12. The image forming apparatus according to claim 1, further comprising a storage configured to store the setting speed of the rotation speed of the motor,
wherein the controller is configured to rotate the motor at a rotation speed based on a setting speed stored in the storage.

13. The image forming apparatus according to claim 12, wherein the controller is configured to:
update the setting speed stored in the storage by changing the setting speed to a speed which is faster by a predetermined speed value in a case where the rotation speed of the motor is to be increased; and
update the setting speed stored in the storage by changing the setting speed to a speed which is slower by a predetermined speed value in a case where the rotation speed of the motor is to be decreased.
